(19) United States
(12) Patent Application Publication
(10) Pub. No.: US 2011/0292392 A1
(43) Pub. Date: Dec. 1, 2011

(54) ABSORPTION OPTICAL PROBE PROVIDED WITH MONITORING OF THE EMISSION SOURCE

(75) Inventors: Stephane Tisserand, Marseille (FR); Marc Hubert, Aix En Provence (FR); Laurent Roux, Marseille (FR); Fabien Reversat, Colomiers (FR)

(73) Assignee: SILIOS TECHNOLOGIES, Peynier (FR)

(21) Appl. No.: 13/139,510

(22) PCT Filed: Dec. 15, 2009
(86) PCT No.: PCT/FR09/01426

§ 371 Date: Jul. 13, 2011

(30) Foreign Application Priority Data
Dec. 16, 2008 (FR) 0807079

(51) Int. Cl. G01N 21/00

(52) U.S. Cl. 356/432

(57) ABSTRACT

The invention relates to an optical probe for measuring absorption in order to produce an absorption value Am, which probe comprises an analysis cell CA, said analysis cell including an emission module LED, F1, HD and a detection module H1, D1 suitable for producing a detection signal DS, the probe also including a monitoring cell CM suitable for producing a monitoring signal MS. The monitoring cell is arranged on the light path connecting the emission module to the detection module.

The present invention relates to an absorption optical probe provided with monitoring of the emission source.

The field of the invention is that of analyzing a fluid, gaseous, or liquid medium by absorption optical spectrometry.

Amongst the numerous potential applications of the invention, particular mention may be made of monitoring potable water. That consists in determining the quantity of organic matter (e.g. bacteria) in suspension in the water. Analysis may be performed over a broad spectrum extending from the near ultraviolet (UV) (e.g. from 250 nanometers (nm)) into the visible. It may also be performed on a reduced set of narrow wavelength bands that are well chosen (in particular 250 nm, 365 nm, 465 nm, and 665 nm).

Such analysis is performed by means of an optical probe that includes an analysis cell provided with an emission module and a detection module. The emission module comprises a light source placed behind a diffusion window appearing in the body of the emission module. A filter is optionally placed between the source and the window (monochromatic or quasi-monochromatic analysis). The detection module includes a detector located behind a port that appears in the body of the detection module. A filter is optionally placed between the port and the detector. The medium for analysis lies between the emission module and the detection module.

In known manner, analysis is performed in two stages. Initially, calibration consists in performing an absorption measurement on a reference medium, perfectly clean water in the present example. Thereafter, measurement proper consists in performing the same operation on the critical medium for analysis. The absorption of the critical medium is weighted by the absorption of the reference medium.

It is found that the emission module is subject to numerous kinds of drift that continue to grow throughout its lifetime. Mention may be made in particular:
of variation in the temperature of the critical medium;
of variation in the power of the emission source;
of variation in the angular profile of the beam emitted by said source;
of variation in the emission spectrum;
of the appearance of and the increase in light noise.

These kinds of drift that cannot be controlled often appear in random manner. It is not possible to estimate when they become sufficiently large to disturb analysis. Unfortunately, each kind of drift requires new calibration in order to have measurements taken under the same conditions on the reference medium and on the critical medium. Calibration operations therefore need to be repeated periodically, and it goes without saying that that constitutes a serious constraint.

Thus, document U.S. Pat. No. 4,037,973 described a device that is sensitive to light for measuring a quantity of particles in a liquid. That device has an emission module and a detection module. It also has a monitoring cell suitable for compensating in part for the above-mentioned kinds of drift. Nevertheless, the monitoring cell does not make it possible to correct adequately the variations that depend on the position of the detector relative to the emission source, and in particular:
lack of uniformity in the critical medium;
variation in the angular profile of the beam emitted by the emission source; and
the three-dimensional distribution of light noise.

An object of the present invention is thus to provide an optical probe for measuring absorption that satisfies a constant concern of the person skilled in the art, namely reducing the number of calibration operations that need to be performed to as few as possible.

According to the invention, an optical probe for measuring absorption in order to produce an absorption value Am comprises an analysis cell, the analysis cell including an emission module and a detection module suitable for producing a detection signal, the probe also including a monitoring cell suitable for producing a monitoring signal; furthermore, the monitoring cell is arranged on the light path connecting the emission module to the detection module.

The monitoring cell serves to compensate for the various kinds of drift mentioned above.

The analysis and monitoring cells are each in the form of a leaktight body presenting an active face.

Thus, the emission module has a light source placed behind a diffusion window appearing in the active face of the analysis cell.

Furthermore, the detection module includes a first detector disposed behind a first port appearing in the active face of the analysis cell.

In addition, the monitoring cell includes a second detector disposed behind a second port that is partially reflective and that appears in its active face.

Preferably, both detectors are identical.

According to an additional characteristic of the invention, the analysis and monitoring cells are connected together by connection means, the active faces of the cells facing each other.

Advantageously, the second port is arranged in such a manner as to reflect part of the beam from the light source towards the first port.

Furthermore, the optical probe further includes a control circuit for producing a measurement signal Qm by weighting the detection signal by means of the monitoring signal.

Preferably, the measurement signal Qm is given by the ratio of the detection signal to the monitoring signal.

By way of example, the control circuit contains the following values in memory:
a reference measurement Qr;
a reference absorption Ar; and
a characteristic length Lc;
   and the absorption value Am is derived from the following expression:

Am=Ar−(Ln((Qm−Qr/Qr)+1)/Lc)

where the term Ln designates the natural logarithm.

Advantageously, the control circuit is provided with temperature compensation.

By way of example, the temperature compensation is performed by means of two constants K1 and K2, a calibration temperature θ₀, and the temperature θ at which the measurement is performed, using the following expression:

Qm(θ)/Qr(θ₀)=exp((Ar−Am)·Lc)·(θ+K1)/(θ₀+K1)·(θ₀+K2)/(θ+K2)

The present invention appears below in greater detail in the context of the following description of an embodiment given by way of illustration and with reference to the accompanying figures, in which:

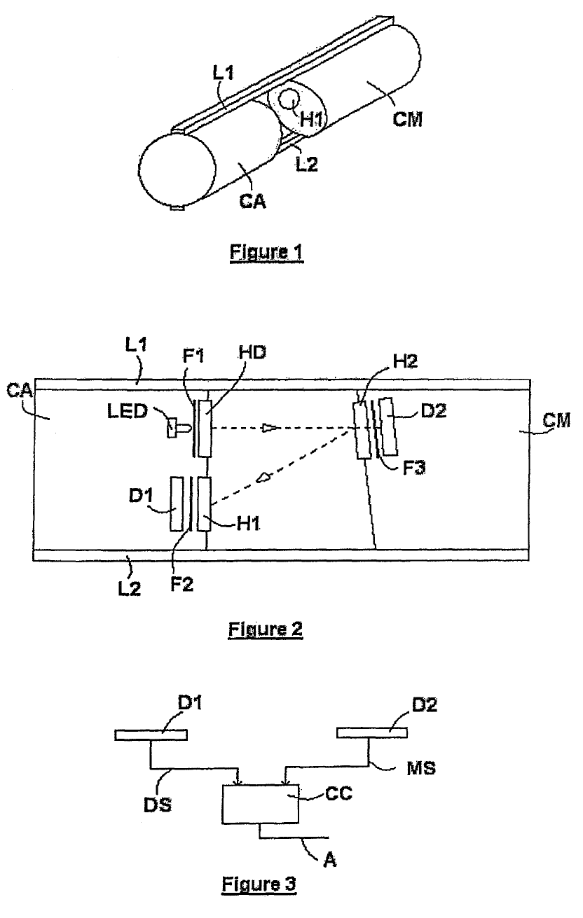

FIG. 1 is a perspective view of an absorption-measuring optical probe;

FIG. 2 is a sectional diagram of the mechanical configuration of this optical probe; and

FIG. 3 is a block diagram showing the electrical configuration of the optical probe.

Elements that are present in more than one of the figures are given the same references in each of them.

With reference to FIG. 1, the optical probe is in the form of two distinct elements, the analysis cell CA and the monitoring cell CM. In this example, both cells are in the form of respective cylindrical bodies. They are connected together by connection means, here in the form of a top bar L1 and a bottom bar L2. The connection is made in such a way that the two cylindrical bodies are on a common axis. The facing faces of these two bodies are referred to below as “active” faces. Naturally, the medium that is to be analyzed lies between these two active faces.

With reference to FIG. 2, the analysis cell CA essentially comprises an emission module and a detection module.

The emission module has a light source LED that illuminates a diffusion window HD located in the active face of the cell. Depending on the nature of the source, it may be necessary to provide a bandpass filter F1 between the source and the window HD. Nevertheless, it is common practice to implement such a source as a light-emitting diode that presents an emission spectrum that is relatively narrow, so the filter is not essential.

The detection module comprises a first detector D1 that is arranged behind a first port H1. This port H1 also lies in the active face of the analysis cell CA close to the diffusion window HD. A filter F2 is optionally interposed between the first port H1 and the detector D1, in particular when there is no filter in the emission module.

Since the medium that is to be analyzed is a fluid, the analysis cell is naturally leaktight. The cell is thus provided with a wall at its end remote from its active face.

The above description assumes implicitly that the body of the cell is opaque to the radiation used for analysis. That should not be seen as being a limitation on the invention, which invention also applies if the body is transparent to said radiation. It can thus readily be understood that the terms “window” or “port” should be understood broadly, i.e. as a transparent surface.

The monitoring cell CM includes a second detector D2 that is arranged behind a second port H2 that appears in its active face facing the active face of the analysis cell. Once more, a filter F3 is optionally interposed between these two elements H2 and D2, particularly if there is no filter in the emission module. The second port H2 is partially reflective.

In order to optimize the performance of the probe, the second detector D2 is preferably identical to the first detector D1. Similarly, both ports H1 and H2 are of the same kind.

The mechanical configuration of the probe is such that the light beam from the light source LED passes in succession through the diffusion window HD, the medium that is to be analyzed, the second port H2, and part of it is finally transmitted to the second detector D2.

Furthermore, the active face of the monitoring cell CM, or at least the second port H2 is inclined relative to the active face of the analysis cell, such that the portion of the light beam that is reflected by the second port H2 passes in succession once more through the medium to be analyzed, the first port H1, and is finally transmitted to the first detector D1.

Thus, the second detector D2 lies on the light path connecting the light source LED to the first detector D1.

With reference to FIG. 3, there follows a description of the electrical configuration of the optical probe and of the way in which absorption is measured in the reception band of the first detector D1.

The control circuit CC receives:
a detection signal DS from the first detector D1; and
a monitoring signal MS from the second detector.

It produces an absorption coefficient A or any intermediate value that enables said coefficient to be obtained.

The following notation is adopted:
I0, the intensity emitted by the light source LED;
I1, the intensity received by the first detector D1, represented by the detection signal DS,
I2, the intensity received by the second detector D2, represented by the monitoring signal MS;
R, the reflection coefficient of the second port H2;
T, the transmission coefficient of said second port H2;
G2, the attenuation coefficient between the light source LED and the second port H2;
G1, the attenuation coefficient between the light source LED and the first port H1;
L2, the distance between the diffusion window HD and the second port;
L1, the distance between the two ports H1, H2;
A, the absorption coefficient, and more particularly: Ar, said coefficient in the reference medium (stored by the control circuit CC); and Am, said coefficient in the medium that is to be analyzed;
exp, the exponential function; and
Ln, the natural logarithm.

The attenuation coefficients take account of the fact that the detectors do not receive all of the light flux emitted towards them. They depend on geometrical considerations and are therefore independent of the absorption coefficients that depend specifically on the physicochemical properties of the medium being analyzed.

The intensity received by the second detector is given by:

I2=I0·T·G2·exp(−A·L2)

The intensity received by the first detector is given by:

I1=I0·R·G1·exp(−A·(L2+L1))

It should be emphasized here that in order to optimize the sensitivity of the probe, the second port is designed so that the two intensities I2 and I1 are of the same order of magnitude. The partial reflection on this port may be obtained in various ways, and in particular by:
a thin coating of metal;
a layer of metal that is opaque and reflective having openings formed therein in a checkerboard, row, . . . , pattern;
a mirror presenting a central opening; or
a mirror partially overlying the port.

The measurement Q is thus defined as the ratio between the intensity received by the first detector and the intensity received by the second detector:

Q=I1/I2

Q=((R·G1)/(T·G2))·exp(−A·L1)

The expression (R·G1)/(T·G2) is a constant that is written K:

Q=K·exp(−A·L1)

It can be seen that only the distance L1 between the two ports is involved, which distance is thus the characteristic length Lc of the optical probe (Lc=L1).

This characteristic length Lc is stored in the control circuit CC.

Calibration in the reference medium, clean water in the present example, gives the reference measurement Qr:

Qr=K·exp(−Ar·Lc)

This reference measurement is also stored by the control circuit CC.

The measurement in the medium that is to be analyzed gives the measurement signal Qm:

Qm=K·exp(−Am·Lc)

From which:

(Qm−Qr)/Qr=exp((Ar−Am)·Lc)−1

The control circuit thus produces the looked-for absorption coefficient Am:

Am=Ar−(Ln(((Qm−Qr)/Qr)+1)/Lc) (1)

Other means are available for obtaining the absorption coefficient Am of the medium under analysis. For example, the ratio of the measurement signal Qm to the reference signal Qr may be calculated directly:

Qm/Qr=exp((Ar−Am)·Lc)

whence

Am=Ar−(Ln(Qm/Qr)/Lc) (2)

Equations (1) and (2) are equivalent, and the invention covers any solution that derives from the principle explained above.

Temperature compensation may optionally be provided in order to take account of the fact that the calibration and the measurement proper are not performed at the same temperature.

It is assumed that intensity varies linearly as a function of the temperature θ, these variations being quantified by means of four constants α, β, χ, and δ:

The intensity received by the second detector is now given by:

I2(θ)=I0·T·G2·exp(−A·L2)·(χθ+δ) (3)

The intensity received by the first detector is given by:

I1(θ)=I0·R·G1·exp(−A·(L2+L1))·(αθ+β) (4)

The measurement Q(θ) is always the ratio of the intensity received by the first detector to the ratio of the intensity received by the second detector:

Q(θ)=I1(θ)/I2(θ)

Q(θ)=K·exp(−A·Lc)·(αθ+β)/(χθ+δ)

Calibration is then performed in a reference medium for which the absorption is known at the calibration temperature θ₀:

Q(θ₀)=K·exp(−Ar·Lc)·(αθ₀+β)/(χθ₀+δ)

The measurement in the medium for analysis at the temperature θ gives the measurement signal Qm(θ):

Qm(θ)=K·exp(−Am·Lc)·(αθ+β)/(χθ+δ)

Whence:

Qm(θ)/Qr(θ₀)=exp((Ar−Am)·Lc)·(αθ+β)/(χθ+δ)·(χθ₀+δ)/(αθ₀+β)

Qm(θ)/Qr(θ₀)=exp((Ar−Am)·Lc)·(θ+β/α)/(θ₀+β/α)·(θ₀+δ/χ)/(θ+δ/χ)

β/α and δ/χ are determined experimentally. For a liquid in which absorption does not vary with temperature, the characteristic of the intensity I1(θ) received by the first detector as a function of temperature θ is established using two constants a and b:

I1(θ)=aθ+b

Identifying this equation with equation (4), it can be seen that:

a=I0·R·G1·exp(−A·(L2+L1))·α

b=I0·R·G1·exp(−A·(L2+L1))·β

It is easy to deduce therefrom the ratio K1=β/α which is equal to the ratio b/a.

The same procedure is then followed to establish the characteristic of the intensity I2(θ) received by the second detector as a function of temperature θ so as to obtain the ratio K2=δ/χ.

These two ratios K1 and K2 characterizing temperature variations are stored in the control circuit CC, as is the calibration temperature θ₀. Furthermore, a sensor (not shown) informs the control circuit CC of the temperature θ at which the measurement is taken.

The optical probe of the present invention performs an absorption measurement by comparing the optical properties of a critical medium with those of a reference medium.

Calibration is performed once and for all before putting the probe into operation, since the monitoring cell makes it possible to overcome the various kinds of drift mentioned above in the introduction. Calibration may optionally be repeated from time to time, if only for safety reasons.

The mechanical design is modular, which means that it is possible to juxtapose a plurality of probes on a common axis, each probe taking a specific spectrum band into account. It is thus possible to provide the probes with pins (not shown) at their ends in order to make them easier to assemble together.

By way of example, for analyzing water, provision may be made for a single probe centered on the wavelength 250 nm, but it is also possible to provide three probes centered on the wavelengths 250 nm, 365 nm, and 465 nm.

It is even possible to put two distinct light sources in the same probe, providing they are not both activated simultaneously.

The embodiments of the invention described above are selected because of their concrete nature. Nevertheless, it is not possible to list exhaustively all embodiments covered by the invention. In particular, any of the means described may be replaced by equivalent means without going beyond the ambit of the present invention.

1. An optical probe for measuring absorption in order to produce an absorption value Am, the probe comprising an analysis cell (CA), said analysis cell including an emission module (LED, F1, HD) and a detection module (H1, D1) suitable for producing a detection signal (DS), the probe also including a monitoring cell (CM) suitable for producing a monitoring signal (MS), the probe being characterized in that the monitoring cell is arranged on the light path connecting said emission module to said detection module.

2. An optical probe according to claim 1, characterized in that said analysis and monitoring cells (CA and CM) are each in the form of a leaktight body presenting an active face.

3. An optical probe according to claim 2, characterized in that said emission module has a light source (LED) placed behind a diffusion window (HD) appearing in said active face of said analysis cell (CA).

4. An optical probe according to claim 3, characterized in that said detection module includes a first detector (D1) disposed behind a first port (H1) appearing in said active face of said analysis cell (CA).

5. An optical probe according to claim 4, characterized in that said monitoring cell (CM) includes a second detector (D2) disposed behind a second port (H2) that is partially reflective and that appears in its active face.

6. An optical probe according to claim 5, characterized in that both detectors (D1, D2) are identical.

7. An optical probe according to claim 5, characterized in that said analysis and monitoring cells (CA, CM) are connected together by connection means (L1, L2), the active faces of said cells facing each other.

8. An optical probe according to claim 7, characterized in that said second port (H2) is arranged in such a manner as to reflect part of the beam from said light source (LED) towards said first port (H1).

9. An optical probe according to claim 1, characterized in that it further includes a control circuit (CC) for producing a measurement signal Qm by weighting said detection signal (DS) by means of said monitoring signal (MS).

10. An optical probe according to claim 9, characterized in that the measurement signal Qm is given by the ratio of said detection signal (DS) to the monitoring signal (MS).

11. An optical probe according to claim 10, characterized in that said control circuit (CC) contains the following values in memory:
a reference measurement Qr;
a reference absorption Ar; and
a characteristic length Lc;
and said absorption value Am is derived from the following expression:
Am=Ar−(Ln(((Qm−Qr)/Qr)+1)/Lc)
where the term Ln designates the natural logarithm.

12. An optical probe according to claim 11, characterized in that said control circuit (CC) is provided with temperature compensation.

13. An optical probe according to claim 12, characterized in that said temperature compensation is performed by means of two constants K1 and K2, a calibration temperature θ₀, and the temperature θ at which the measurement is performed, using the following expression:
Qm(θ)/Qr(θ₀)=exp((Ar−Am)·Lc)·(θ+K1)/(θ₀+K1)·(θ₀−K2)/(θ+K2)
